(19) United States
(12) Patent Application Publication
(10) Pub. No.: US 2013/0320863 A1
(43) Pub. Date: Dec. 5, 2013

(54) LIGHTING DEVICE AND A LIGHTING SYSTEM

(71) Applicants: Sarah Anne Mitchell, Oxford (GB); David James Montgomery, Oxford (GB); James Rowland Suckling, Surrey (GB); Stefan Rohrmoser, Munchen (DE)

(72) Inventors: Sarah Anne Mitchell, Oxford (GB); David James Montgomery, Oxford (GB); James Rowland Suckling, Surrey (GB); Stefan Rohrmoser, Munchen (DE)

(73) Assignee: SHARP KABUSHIKI KAISHA, Osaka (JP)

(21) Appl. No.: 13/985,108

(22) PCT Filed: Feb. 23, 2012
(86) PCT No.: PCT/JP2012/055149

§ 371 Date: Aug. 13, 2013

(30) Foreign Application Priority Data
Feb. 23, 2011 (GB) 1103085.5

(51) Int. Cl. H05B 33/08

(52) U.S. Cl. CPC H05B 33/0854
USPC 315/153

(57) ABSTRACT

A lighting device comprises a plurality of light sources (61) fixedly mounted on a support. At least one of the light sources is operable independently of the other light source(s), and optionally every one of the light sources is operable independently of every other light source. The lighting device has an optical system (62) for directing light from each light source along respective directions different from one another. The axes and illumination patterns of the optical system subscribe 360° in the plane of the lighting device. The lighting device is preferably operable in at least a first mode in which the lighting device provides directional lighting and a second mode in which the illumination provided by the lighting device subscribes substantially 360° in the plane of the lighting device.

### TECHNICAL FIELD

This invention relates to a lighting device, and to a lighting system comprising a lighting device.

### BACKGROUND ART

The first instances of artificial lights were generally omni-directional, and this is still the tendency of modern day filament light bulbs and their replacements. As demonstrated by the continuing popularity of these light sources, a wide angle light source is often desirable however there are instances when a light source with greater directionality is more suitable.

Directional lighting is of course well known; spotlights have existed in many guises for years. However, due to their highly directed emission, spotlights are not usually sufficient in most general purpose lighting environments. Thus, many lighting systems rely on a combination of wide angle and highly directed light sources, requiring many individual light fittings.

Light sources with variable angle emission profiles are also well known—for example in torches with spot and wide angle features—but in these cases the system is then limited in use to a single direction unless adjusted by a physical movement.

Examples also exist where inventors have attempted to direct or reshape the emission pattern from one or more light sources, the most pertinent examples are listed below;

U.S. Pat. No. 7,080,924B2 (Harvatek Corp., 25 Jul. 2006); this patent proposes a light bulb with reflective walls 1 between LED light sources 2 as shown in FIG. 1. The reflective walls are angled in order to diverge the light emitted from the light sources. Where three LED light sources 2 and three reflective walls 1 are provided as shown in FIG. 1, the light reflected from the walls 1 becomes hemispherically omni-directional.

U.S. Pat. No. 7,641,372B2 (Peter Panopulos, 5 Jan. 2010) proposes a headlamp design for vehicles. The design uses a multiplicity of filaments 21,22 and reflectors 23,24 as shown in FIG. 2. The reflectors are arranged such that light from a light source is directed in a non-parallel direction to light from the other sources. Individual light sources and mirrors may be rotated by a motor to provide directional control over the light as indicated by the alternative positions for the reflector 24 shown in broken lines.

U.S. Pat. No. 5,642,933 (Patlight corp., 1 Jul. 1997) proposes a signal lamp with a plurality of light sources 31 and reflectors 32, in which each reflector directs light into a specific direction as shown in FIG. 3. This invention aims to use fewer light sources, and reduce the point-like appearance of light compared to previous signal light systems whilst emitting light into a wide angular range.

EP 0 426 397 (Hewlett-Packard, 8 May 1991) proposes an LED lighting optic designed to provide an asymmetrical light pattern by controlling the maximum angle of emission from the optic axis of the system. The light distribution is achieved through a single reflector cup 41 combining circular and parabolic cross-sections as shown in FIG. 4.

EP 1 826 474 (Optics Lite S.r.L., 29 Aug. 2006) proposes an optical projector having a plurality of light sources 51 having their emission axes substantially radial with respect to the axis of the projector. Light from the light sources 51 is reflected by respective concave reflective surfaces 52 so that the reflected light beams are substantially parallel to the axis of the projector.

CN 201561318 (24 Sep. 2009) and WPI Abstract accession number 2010-L77422 proposes a lamp having a plurality of lamps. Each lamp is mounted on a respective flexible post. The position and/or orientation of each lamp can be altered by a mechanical adjustment of the post on which the lamp is mounted.

A final example of directed light is provided by Panasonic, who have a ceiling light tile which contains both downwards emitting diffuse light units, and side-emitting modules, designed to emit light onto a ceiling for indirect illumination. The side-emitting light modules are individually controllable.

The prior art outlined above, although addressing aspect of directional control with lighting, fails to offer a workable solution that combines both well-directed illumination in useful areas with a minimum of light fittings and no need to mechanically adjust the positions or directions of these fittings. This invention seeks to address that deficiency.

US 2009/0207038 proposes an “electronic flare”, for example for use on a road vehicle to warn other users after an accident. The flare has a plurality of LEDs mounted on the circumference of a cylindrical support, and also on an upper surface of the support. A protective lens is provided over the LEDs.

### SUMMARY OF INVENTION

As outlined above, the prior art does not offer a straightforward route to applying an easily adaptable aspect to lighting. Although it is possible to create a lighting effect that combines wide angle and spot-lighting effects, this requires the use of multiple light units or mechanical movement of the lights.

A first aspect of the invention provides a lighting device comprising a support; a plurality of light sources fixedly mounted on the support, at least one of the light sources being operable independently of the other light source(s), the lighting device having an optical system for directing light from each light source along respective directions different from one another, wherein the axes and illumination patterns of the optical system subscribe substantially 360° in the plane of the lighting device; wherein the lighting device comprises a controller for controlling the light sources such that the lighting device is operable in at least a first mode in which the lighting device provides directional lighting.

This aspect of the invention provides a lighting device which is operable in at least a directional lighting mode without the need to mechanically adjust the positions of the light sources.

The controller may be adapted to control the light sources such that the lighting device is operable in a second mode in which the illumination provided by the lighting device subscribes substantially 360° in the plane of the lighting device.

The controller may be adapted to control each light source independently of the other light sources.

The lighting device may comprise N light sources, where N is a positive integer, the light sources being disposed such that a line from a centre of the lighting device to one light source is at an angle of substantially 360°/N to a line from the centre of the lighting device to an adjacent light source. For example the lighting device may have 4 light sources (ie N=4) arranged regularly such that lines from two adjacent light source to the centre of the lighting device are at an angle of 90° to one another. However, the invention is not limited to 4 light sources, and may have 2 or 3 light sources or may have 5 or more light sources. Moreover, the invention does not require that the light sources are arranged regularly.

The optical system may comprise a plurality of first optical elements, each first optical element being associated with a respective source and being adapted to direct light from its associated light source along a respective direction.

The optical system may be a reflective optical system.

Each first optical element may be a reflector. Each first optical element may be a specular reflector, or a diffuse reflector. The reflector cross-section may for example be cylindrical, parabolic or elliptical, although the invention is not limited to these specific cross-sections. Moreover, the reflector cross-section may vary along the length of the reflector.

Alternatively, each first optical element may be a lens, or may be a lightguide.

The optical system may further comprise a plurality of second optical elements, each second optical element disposed in the path of light from a respective one of the first optical elements.

The second optical elements may comprise lenses, prism arrays or diffusers.

Alternatively, the optical system may further comprise a second optical element disposed in the paths of light from the first optical elements.

The second optical element may be a diffuser, a lens, or a reflector.

The optical system may be arranged to restrict the emission of light in a direction substantially perpendicular to the plane of the lighting device.

At least one of the light sources may have different spectral characteristics to at least another one of the light sources, for example different emission wavelengths or different emission wavelength ranges, or different colour temperature.

At least one, and optionally all, of the light sources may comprise a plurality of light-emitting elements.

At least one of the light emitting elements in a light source may be operable independently of the other light emitting element(s) of the light source. Optionally, every light emitting element in a light source may be operable independently of every other light emitting element of the light source

At least one of the light-emitting elements of a light source has different spectral characteristics to at least another one of the light-emitting elements of the light source.

A second aspect of the invention provides a lighting system comprising a lighting device of the first aspect and one or more sensors, the or each sensor providing a respective output signal as an input to the controller.

The or each sensor may be adapted to sense the presence of a person.

The or each sensor may be adapted to sense the presence of a vehicle.

The or each sensor may be adapted to sense the level of ambient illumination.

This invention combines multiple light sources within one ‘light fitting’, and additional optical elements to control the directionality of each light source within this fitting. These features can be, for example, shaped mirrors to restrict and redirect the emission of light. The optical elements can be designed so as to provide a directional beam from each light source, but keeping a wide angle distribution from the combined sources.

The immediate advantage of this invention is that it provides controllable, adaptable, lighting from a single fitting without physical movement of the fixture or light source.

Another advantage of this system that the single lighting device may be used to balance light levels in a room—for example to compensate for a brighter area near a window, by dimming levels in that area, or increasing the brightness elsewhere.

A further advantage is an ability to dim the lights in the vicinity of screens or other display devices, and thus avoid direct illumination and glare, from these objects. Contrast and ease of viewing may be improved in this manner too, whilst maintaining a normal level of illumination elsewhere in the room.

An additional advantage of this invention is that it maximises the energy efficiency of the lighting device; direct switching or dimming of sources relating to areas where illumination is not necessary ensure that there is no wastage of light or energy.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIGS. 1 to 5. Conventional light sources;

FIG. 6. Basic schematic of lighting device;

FIGS. 7(a) and 7(b). perspective and plan views of example reflector design;

FIG. 8. Possible angular profile of illumination from light source;

FIGS. 9(a) and 9(b). Alternative reflector geometries;

FIG. 10. Diffuse reflector;

FIG. 11. Example of lighting device with different colour or colour temperature light sources;

FIG. 12. Illustration of a reflector with non-constant cross-section;

FIG. 13. An example reflector and lens arrangement;

FIG. 14. An example reflector and BEF-like lens arrangement;

FIG. 15. A possible arrangement of a optical element including a diffusive component;

FIG. 16. The lighting device including a protective cap comprising optical elements;

FIGS. 17(a) and 17(b). A plan view and a perspective view of an example of a lighting device with non-coplanar light sources;

FIG. 18. A lighting device with wireless controller;

FIG. 19. An example of a lighting device with sensors built in to the device;

FIG. 20. A reflector cup encompassing all light sources and optical elements;

FIGS. 21(a) and 21(b). A side view and a plan view of a light source with an individual reflector cup, for further control of light emission;

FIG. 22. An example reflector with a curved profile;

FIG. 23. Multiple light devices illuminating a room;

FIGS. 24(a) and 24(b). Lighting devices according to two further embodiments of the invention;

FIGS. 25(a) and 25(b). A lighting device according to a further embodiment of the invention;

FIG. 26. A lighting device according to a further embodiment of the invention.

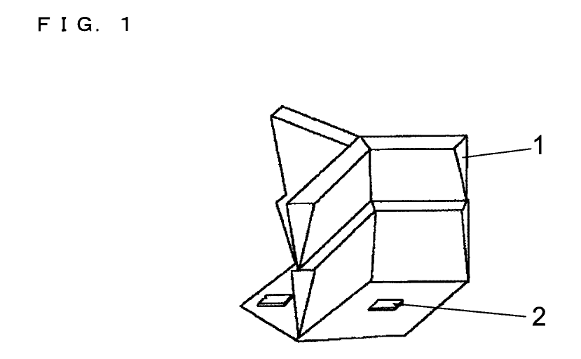

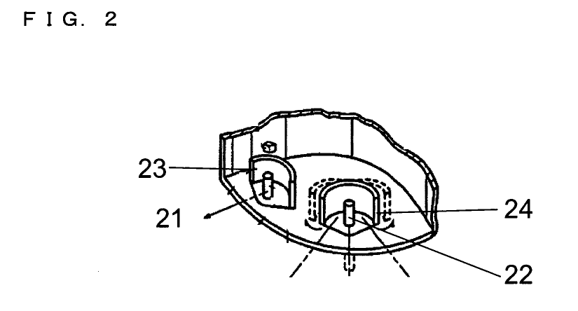

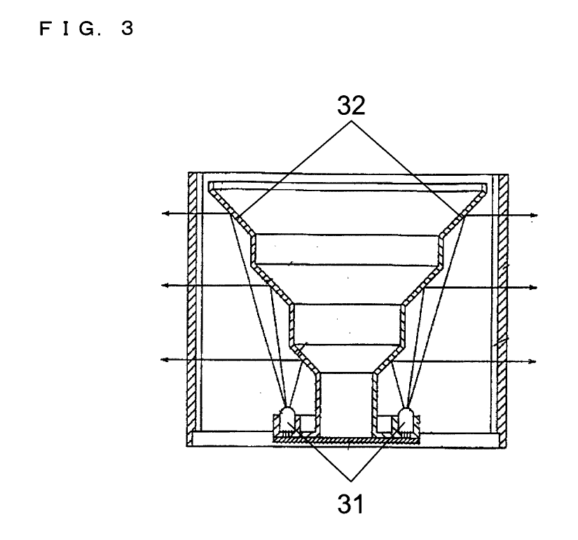

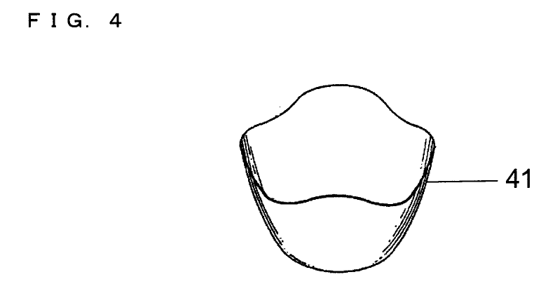

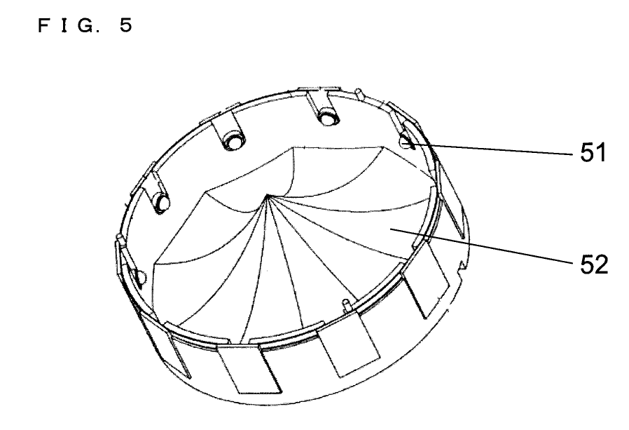

### DESCRIPTION OF REFERENCE NUMERALS

60. lighting device
61. light source
62. optical element.
63. control mechanism such as switch
64: support
70. reflective surface of mirrored optical element
90. parabolic cross section
91. elliptical cross section
100. diffusely reflecting surface
110. light source of specific colour or colour temperature
111. light source of different colour or colour temperature to
110
130. lens
140. BEF-like lens
150. diffuser/scattering surface
160. cover/cap with optical elements
180. wireless control device
181. wireless signal receiver
190. sensor
200. reflector cup surrounding all optical elements and individual light sources
210. reflector cup for single light source
230. zones of illumination from lighting devices

### DESCRIPTION OF EMBODIMENTS

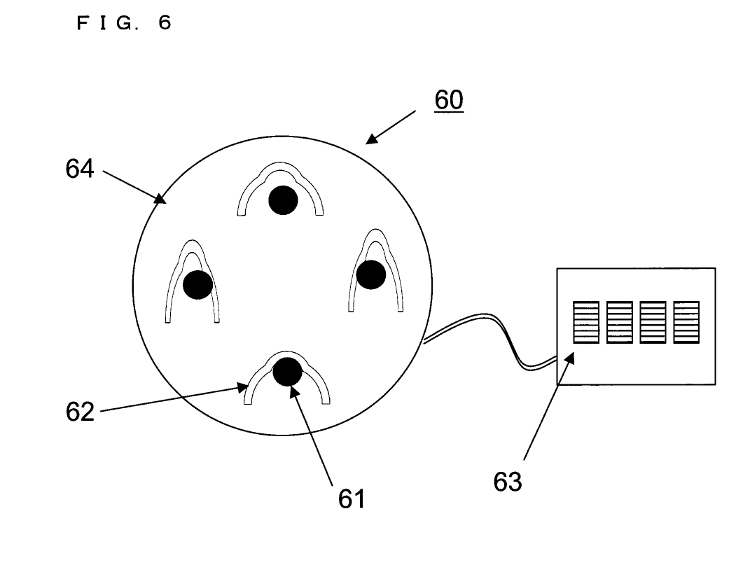

The first embodiment, shown in FIG. 6, is a lighting device 60 that combines multiple coplanar light sources 61 such as, but not limited to, LEDs or halogen light sources, and combines each light source with a distinct and fixed optical element 62 such as a specular mirror. The light sources 61 are fixedly mounted on a support 64—with the lighting device 60 oriented as shown in FIG. 6 the support 64 acts as a base, but the invention is not limited to the lighting device 60 being used in the exact orientation shown in FIG. 6. The optical elements 62 together form an optical system for directing light from each light source along respective directions different from one another. The axes and illumination patterns of the optical system subscribe 360° in the plane of the lighting device.

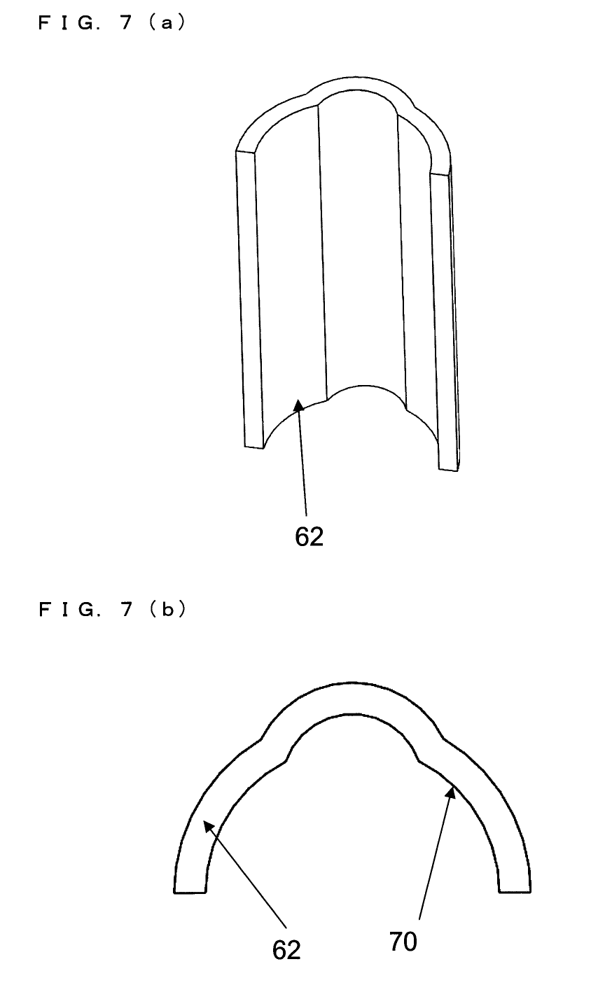

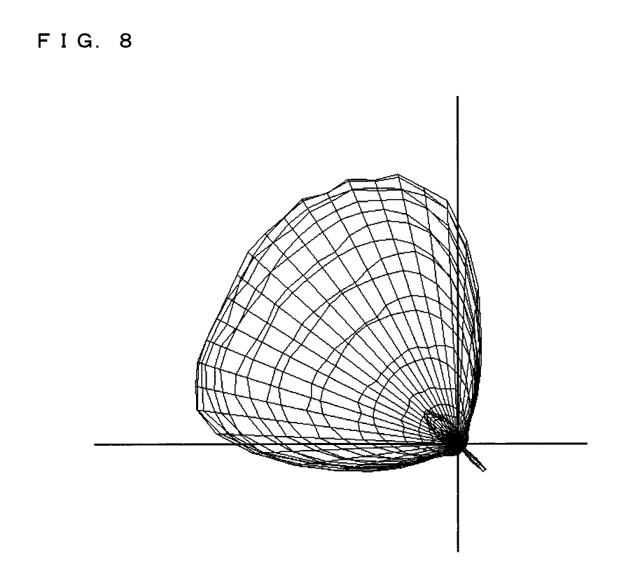

Each optical element is designed to direct the light from the source into a specific direction. This may be achieved, for example by a cylindrical mirrored surface 70 with a cross section comprised of one or more circular arcs, as shown in FIGS. 7(a) and 7(b). The distribution from such an arrangement, viewed looking along the long axis of the reflector, is seen in FIG. 8. The optical elements 62 are positioned relative to the light source so that the light sources 61 emit into substantially different directions. There may be N light sources arranged regularly such that two adjacent light sources are at an angle of substantially 360°/N when seen from the centre of the lighting device; for example, FIG. 6 illustrates four light sources and reflectors which are arranged to emit into quarters of the hemisphere above the light sources, corresponding to 0-90°, 90-180°, 180-270°, and 270-360° when considered in the plane of the light sources. However, a different number of light sources and/or non-equal angular distributions would be just as valid. The overall effect of the optical elements when all light sources are illuminated is designed to be largely similar to that of the combined light sources without the individual optical elements. Each individual light source in the lighting system is controlled by separately, for example by a switch or dimmer switch 63. Dimming may be achieved through resistive or current pulsing means. It is therefore possible to obtain two or more different illumination patterns from the lighting device 60 simply by controlling the intensities of the individual light sources. There is no need for the light sources to be mounted on mechanically adjustable mounts, and each light source may be mounted on the support 64 at a fixed respective location and in a fixed respective orientation with respect to the support.

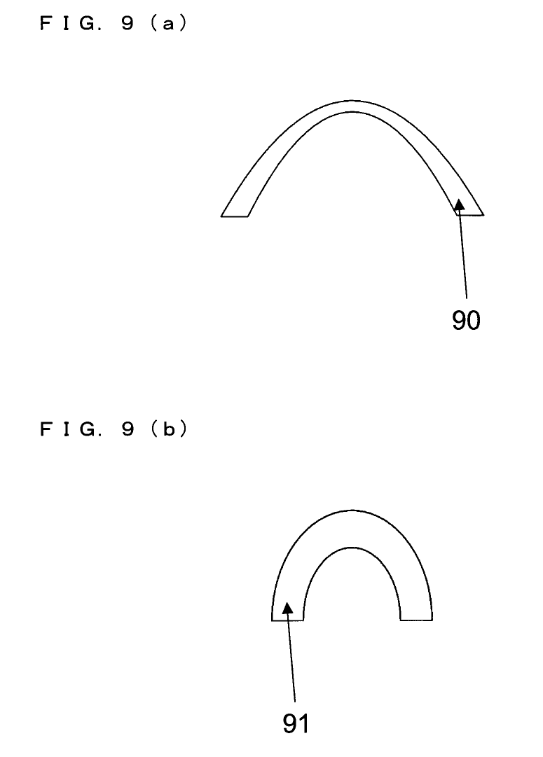

Embodiments two and three are as the first embodiment, but allowing for alternative reflector cross sections, such as parabolic or elliptical arcs, or other curved or straight sections. Examples of parabolic 90 and elliptical 91 cross sections are seen in FIGS. 9(a) and 9(b), but many combinations of straight and curved sections could potentially be used depending on the exact angular distributions required.

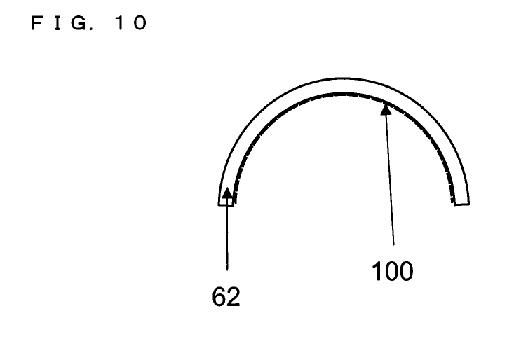

Embodiment four is as the previous embodiments, but allowing for diffuse reflection rather than specular reflection from the reflector surface, as shown in FIG. 10. This could be achieved with a coating 100, for example of barium sulphate, in place of a mirrored finish.

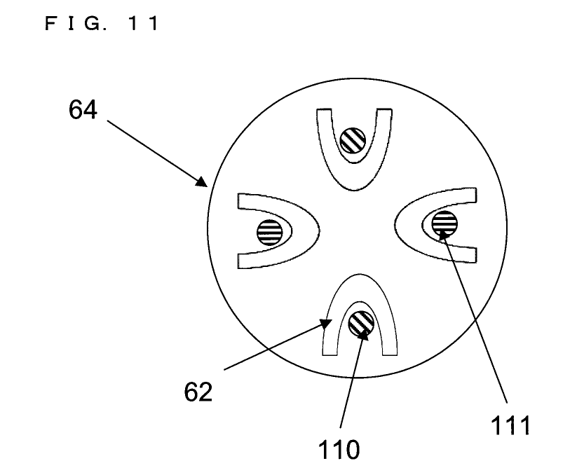

Embodiment five is as the previous embodiments but allowing for coloured light sources, such as, but not limited to, coloured LEDs, white light sources with filters, or white light sources with or operated at different colour temperatures. These could be arranged such that each colour emits over all directions (using multiple sources of the same colour), or that each colour emits into a unique direction. For example, FIG. 11 shows a source with two white light sources 110 and two light sources of a different colour or colour temperature 111. As in previous embodiments the light sources 110,111 are fixedly mounted on a support 64.

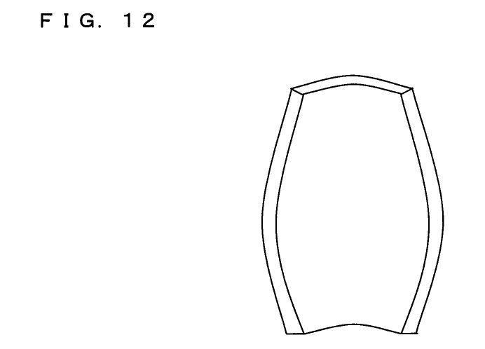

Embodiment six is as the previous embodiments but with the cross section of the reflector not necessarily constant over its length; this may comprise a taper and/or widening of the reflector, as illustrated in FIG. 12.

In embodiments one to six the optical elements in the optical system for directing light from each light source along respective directions are reflectors. The invention is not limited to this, and the optical elements in the optical system for directing light from each light source along respective directions may be any optical element suitable for directing light along desired respective directions. For example, the optical system may comprise lenses for directing light from each light source along respective directions rather than reflectors.

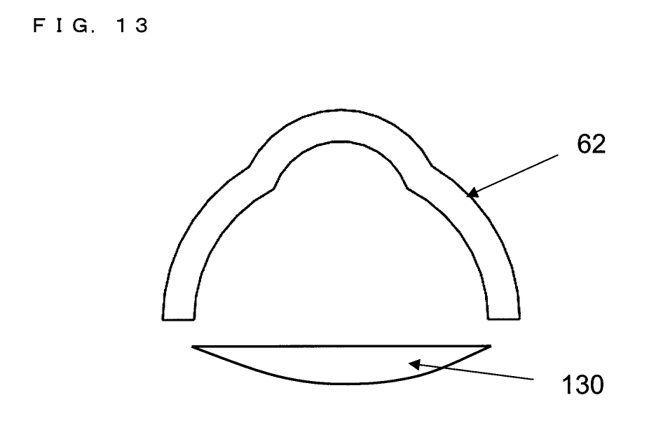

Moreover, the optical system may comprise optical elements of two or more different types. Embodiment seven is as the previous embodiments, with the addition of lenses to provide further control to all or some of the light directed by the light source and reflector, as illustrated in FIG. 13. The lens 130 may positioned directly next to the other optical elements, or more remotely, and may be used to further constrain the angular range of emission from each light source, or to shape the emission distribution without changing the overall angular range further, for example to reduce glare for observers.

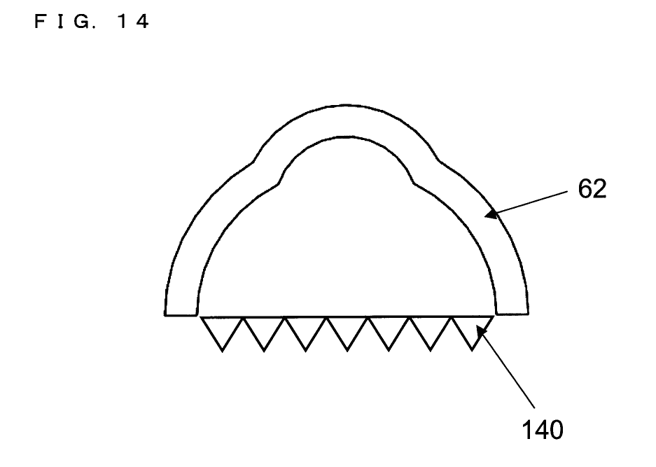

Embodiment eight is illustrated in FIG. 14. This is as embodiment seven but incorporates a BEF-like (Brightness-enhancing film) structure 140 in place of, or in addition to, a lens to further direct the light emission from each optical element. The structure 140 may for example be a prism array.

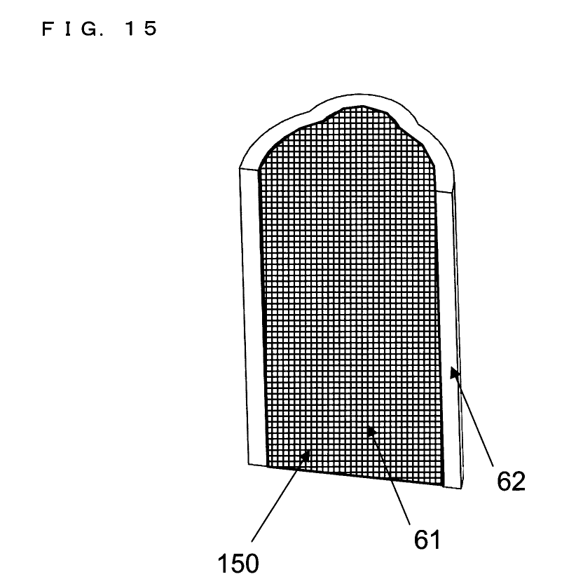

Embodiment nine is as the previous embodiments, but with the addition of a diffusing surface 150, shown in FIG. 15. This diffuser is designed to reduce glare from the light sources without significantly reducing the directional control provided by the optics. The diffuser may be coincident with the light source and optical elements, or removed, for example on a cover over the lighting device. The diffuser may, as shown in FIG. 15, be made cover the entire aperture of the reflector, by bending the top portion of the diffuser over.

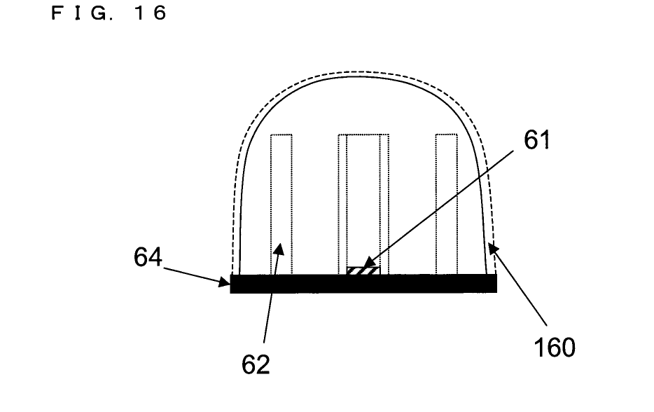

Embodiment ten is as the previous embodiments with optical elements such as, but not limited to, a diffusing effect or lenses, incorporated into a cover or cap 160 over the lighting system. This is shown in FIG. 16.

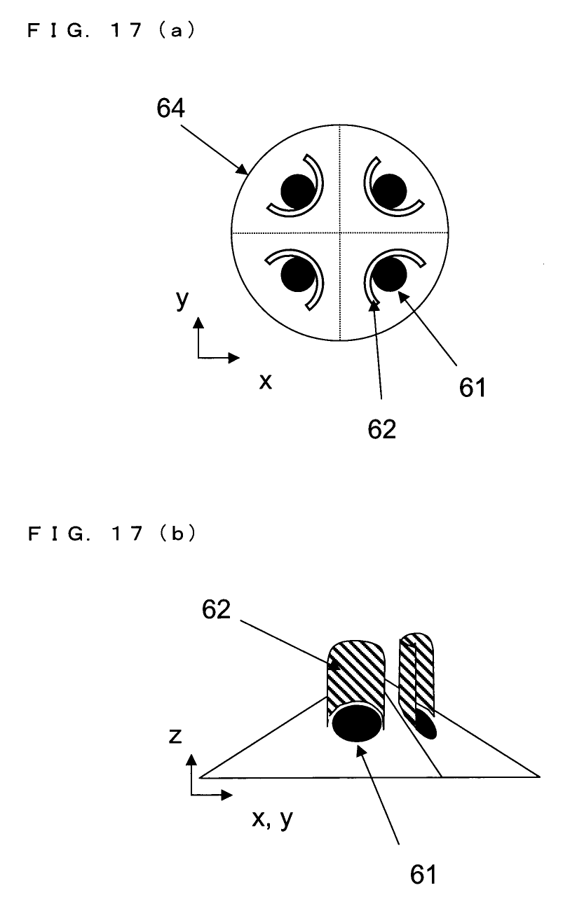

Embodiment eleven is as the previous embodiments but with non-coplanar emitters such as, but not limited to, side emitting LEDs or other light sources mounted at an angle on a support such that the light sources are not coplanar, as illustrated in FIGS. 17(a) and 17(b).

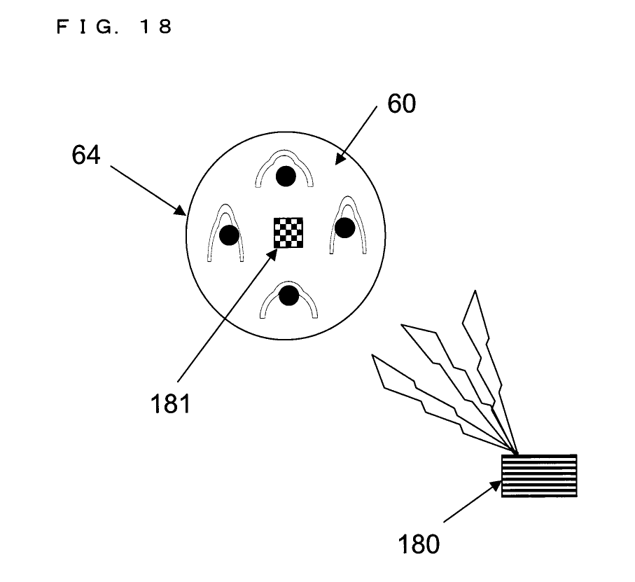

Embodiment twelve is as the previous embodiments but uses wireless control methods to direct the illumination. This control may be, but is not limited to, Bluetooth, infrared, or wifi devices. The control device 161 may be a purpose-built controller, or an application through a computer, mobile telephone, or other electronic device. The lighting device would have a built-in or connected receiver 181 to detect the signal and act upon the control sequence received. This is illustrated in FIG. 18.

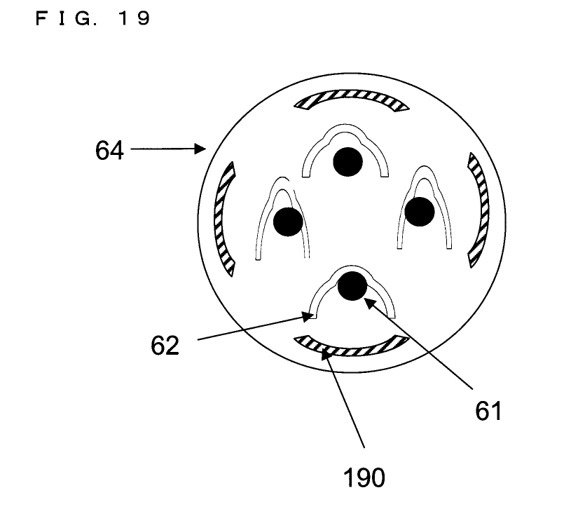

Embodiment thirteen is as the previous embodiments, with the addition of sensor control, either through built-in sensors in the device 190, illustrated in FIG. 19, or through separate, linked sensors, to control which light sources should be illuminated and the level of illumination. The sensors may detect, for example, the presence of people in the vicinity, lighting levels in the room, television or other display devices. Sensors may also be used to detect gestures for controlling the lighting device. Sensor control does not need to be limited to these options, however.

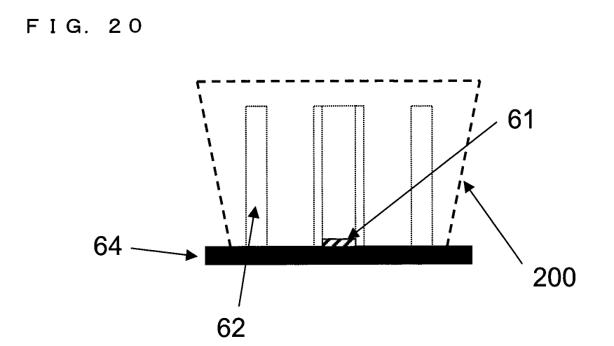

Embodiment fourteen is as the previous embodiments, but allowing for additional optical elements that are not associated with any individual light source and instead control the emission from the entire lighting device, as shown in FIG. 20. For example, this could be a reflector cup 200 which is not associated with any one light source but instead affects the emission from the entire lighting device.

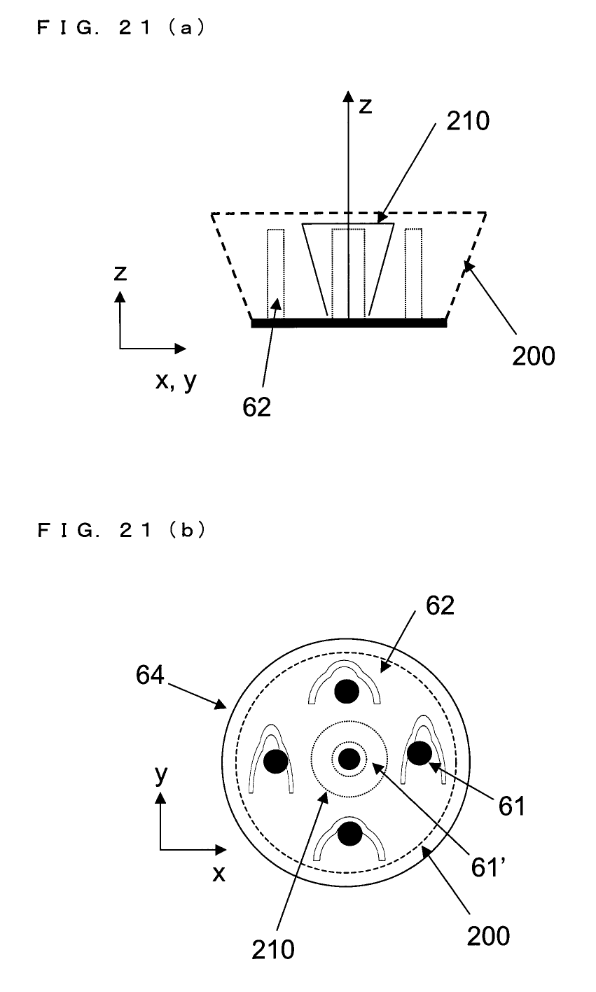

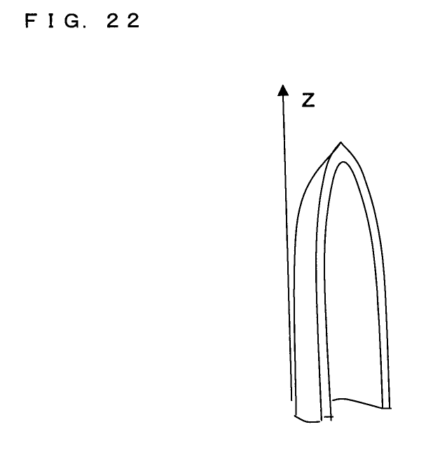

Embodiment fifteen is as the previous embodiments, but adding directional control to each light source 61 in the direction perpendicular to the plane of the device; i.e. restricting emission relative to the z axis as illustrated in FIGS. 21(a) and 21(b). This may be achieved, for example by curving the reflectors relative to the same z axis, as shown in FIG. 22, so that light from the light sources 61 is not directed along the z-axis. This is combined with an additional light source 61′ which is not provided with a reflector 62 and which is not restricted in emission in the plane of the light sources (the x-y plane, perpendicular to the z axis) and so emits into the full 360° in this plane. Instead emission from the additional light source 61′ is restricted in direction relative to that axis, such that the full 90° between the z-axis and the x-y plane is not filled, and light from the additional light source 61′ is directed along the z-axis and at small angles to the z-axis but is not directed along large angles to the z-axis. This may be achieved, for example by an individual reflector cup or lens 210. The result is that emission from the additional light source 61′ fills in the gap in emission created by restricting emission from the other sources 61 relative to the z axis. Thus if only the additional light source 61′ is illuminated light is emitted along the z-axis and at small angles to the z-axis, if only the light sources 61 are illuminated light is emitted at large angles to the z-axis but not along or at small angles to the z-axis, and if the additional light source 61′ and the light sources 61 are illuminated light is emitted along the z-axis and at small angles to the z-axis and also at large angles to the z-axis. Adding in control in this extra dimension allows overall emission from the lighting device to be pixellated, with each pixel individually controllable in brightness. The pixels may be, but do not have to be, regular sizes.

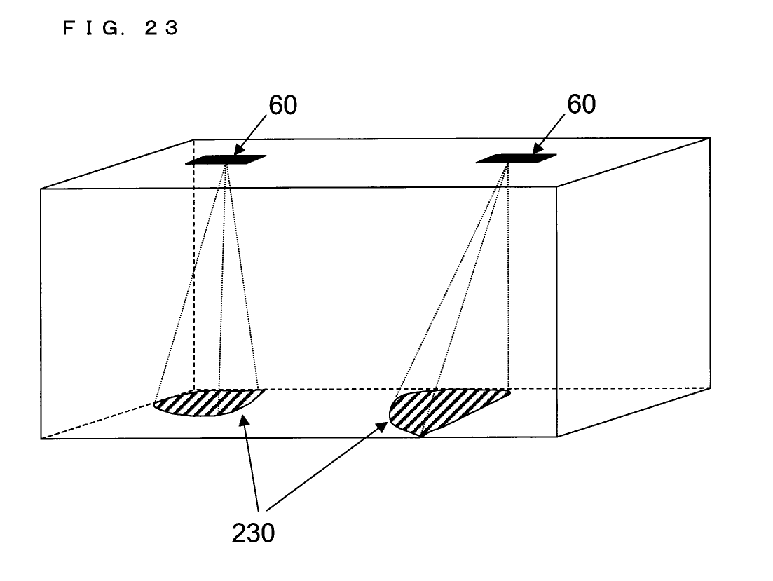

Embodiment sixteen uses multiple lighting devices 60 of the present invention, which may for example be lighting devices described in any one of the previous embodiments to illuminate a space such as a room, as illustrated in FIG. 23. The multiple devices may be set up to illuminate all or some of the space, and controlled in such a way as to allow specific illumination of small sections or zones of the space 230 whilst preventing (direct) illumination of other areas.

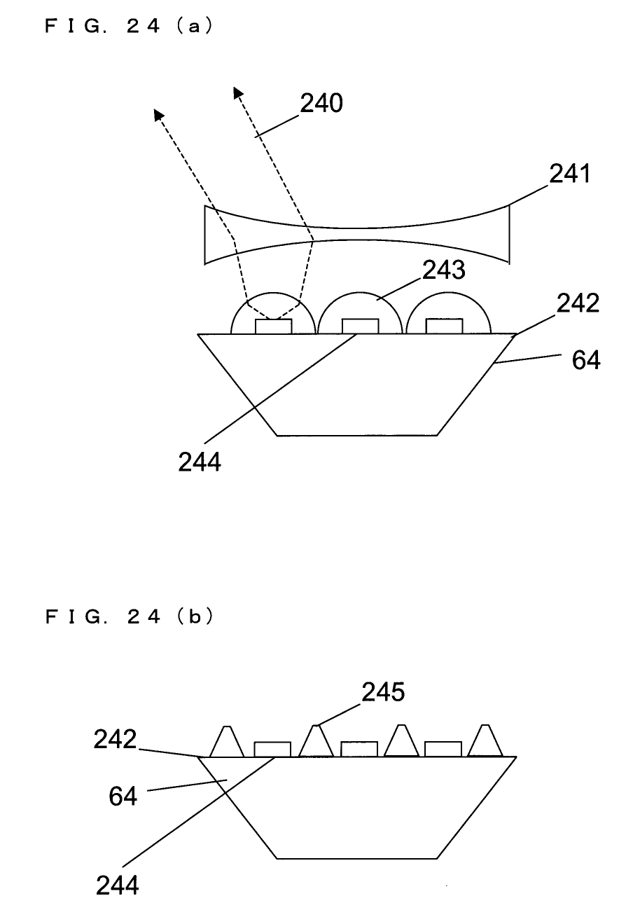

A further embodiment of the invention is shown in FIGS. 24(a) and 24(b) and is described with reference to the preferred embodiment and the differences are described. In this arrangement the light sources (e.g. white LEDs), 244, are arranged in a regular pattern on the top surface of a heat sink 242 and are driven with known electronics methods, whereby the sources can be individually controllable. Each source has a convex optical structure 243, for example a lens, on its surface where the optical structure substantially collimates the emitted light, though the requirement is that the angular distribution of light from the optical structure 243 is narrower than the angular distribution of light from the light sources 244 would be in the absence of the optical structure. Instead of the lens, the LEDs can be positioned in reflecting chambers 245 which will also part-collimate the light (FIG. 24b), or the embodiments may be combined so that the light sources 244 are positioned in reflecting chambers and are provided with optical structures such as lenses. Above the lens or chamber arrangements is placed a single divergent lens 241, which diverges the semi-collimated light such that light from different light sources 244 is directed into different directions 240.

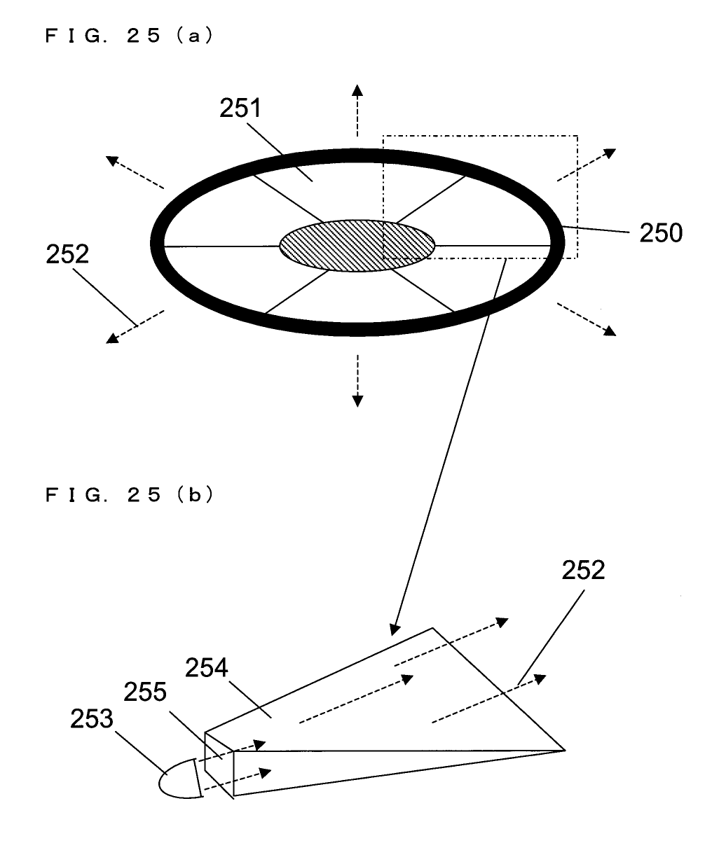

This invention describes bulb arrangements but the essential concept can be applied to light sources of various geometries. For example this invention can be applied to a segmented lightguide based circular room lamp or a segmented desk lamp, as are shown in FIGS. 25(a) and (b) and 26. The optics in this case can be similar to that described in the above applications or may be lightguides associated with each structure.

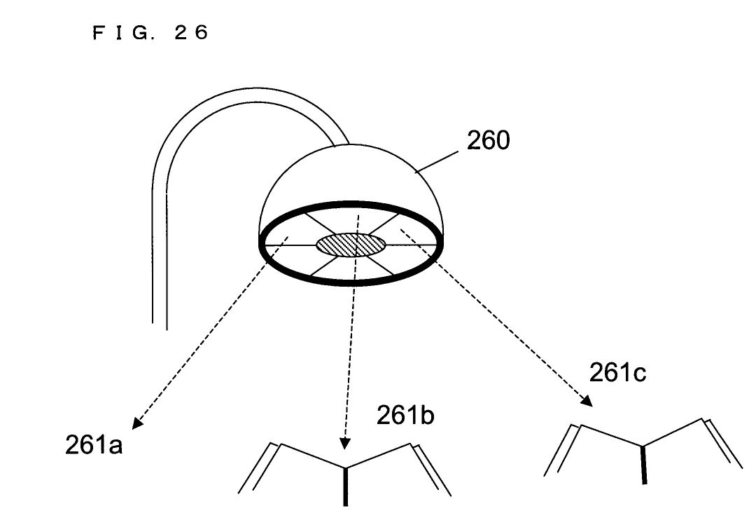

In FIG. 25, a circular segmented lighting system 250 consists of two or more lighting segments 251, individually emit light 252, so that when all segments are on, a broad illumination pattern is created. The individual segments, however illuminate in specific directions or in specific parts of the room and these segments can be individually controllable. One potential way for this to be realised is shown in FIG. 25b in which a semi-collimated light source 253 in-couples light 255 into a lightguide 254. Extraction from the lightguide is controlled in order to extract collimated light 252 from the lightguide. Other alternative ways are for the collimated LED structures described in previous embodiments to be applied in this case. A small diffuser (not shown) can be used in this case to remove non-uniformities from overlapping illumination. FIG. 26 illustrates a similar system 260 used as a desk or reading lamp for the home, hotel or on aircraft, where multiple independently controllable illumination areas 261a, 261b and 261c (for example) are required. Other applications such as wall lights or up-lighters can also be envisaged in the same regard.

In the embodiments described above each light source may consist of a single light-emitting element. The invention is not limited to this however, and one or more of the light sources may consist of two or more light-emitting elements. This may be of particular benefit in embodiments in which it is desired to provide directional control in the direction perpendicular to the plane of the lighting device—by implementing a light source as two or more individually controllable light-emitting elements having associated optical systems arranged to direct light along different directions relative to the plane of the lighting device, directional control of the illumination in the direction perpendicular to the plane of the lighting device may be obtained. Alternatively, the light-emitting elements forming one light source may have different spectral characteristics from one another, for example may emit light of different wavelengths to one another, to allow the colour of light from the lighting device to be varied.

In the embodiments described above the optical element 62 associated with a light source 61 of the lighting device is separate from the optical elements associated with other light sources of the lighting device. The invention is not however limited to this and the may alternatively be continuous with the optical elements associated with other light sources of the lighting device.

Another application of this invention can be in streetlamps that can be controlled to illuminate in different directions using a sensor arrangement triggered by pedestrians (or vehicles, such as automobiles). The lamps can be used to illuminate areas around and in front of pedestrians.

A further application can involve security lighting where tracking can involve directed lighting towards a potential intruder (or visitor) and track them with their motion. The optics of this invention can also be applied in this arrangement. For example, the controller of a lighting device such as the controller 63 of FIG. 6 may receive inputs from a plurality of sensors such as motion sensors or heat (eg infra-red) sensors, and may control the light sources such that regions where a person is detected as being present are illuminated and other regions are not illuminated.

A further application can be in sunlight compensation. When a room is illuminated by sunlight entering the room through its window(s), it can happen that parts of the room are in shade and so are much darker than parts of the room that in direct sunlight. Where a lighting device of the invention is used to illuminate a room, it may be controlled to illuminate only the parts of the room that are parts of the room are in shade and not illuminate parts of the room that are in sunlight. This produces a more even level of illumination in the room, while saving energy. For example, the controller of a lighting device such as the controller 63 of FIG. 6 may receive inputs from a plurality of brightness sensors, and may control the light sources such that regions of the room that are detected as being in shade are illuminated and other regions of the room are not illuminated. Alternatively, the lighting device may be controlled by a user.

A further application can be in glare reduction. A lighting device of the invention may be controlled such that it does not direct light onto a reflective surface such as, for example, a TV or computer screen, a glass-fronted cabinet, a photograph mounted under glass etc. This reduces glare and also, in the case of for example a TV or computer screen, increases contrast of an image displayed on the screen. This may be effected by arranging the controller of the lighting device to control the light sources appropriately, or alternatively the lighting device may be controlled by a user.

A further application can be in energy-saving. A lighting device of the invention may be controlled such that it provides illumination only where required/desired. For example, a lighting device of the invention may be controlled such that, in daytime, it does not direct illumination onto a window of the room in which the light source is situated—since light incident on the window would be wasted. This may be effected by providing arranging the controller of the lighting device to receive inputs from a plurality of brightness sensors and to control the light sources such that regions detected as being bright are not illuminated, or alternatively the lighting device may be controlled by a user. Alternatively, a lighting device of the invention may be controlled to provide a reading function—for example a person who is reading may control the lighting device such that just one light source is ON to provide a small illuminated area that covers a book that the person is reading, and thereby save energy by not illuminating other areas unnecessarily.

A further application can be in providing mood lighting. If a lighting device of the invention has light sources that emit light of different wavelengths or of different colour temperatures, a user may control the lighting device to provide illumination of a particular wavelength, wavelength combination or colour temperature.

Although the invention has been shown and described with respect to certain preferred embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

This invention would be suitable for retrofit lighting, or for new lighting products in residential, commercial or industrial applications.

1. A lighting device comprising a support; a plurality of light sources fixedly mounted on the support, at least one of the light sources being operable independently of the other light source(s), the lighting device having an optical system for directing light from each light source along respective directions different from one another, wherein the axes and illumination patterns of the optical system subscribe 360° in the plane of the lighting device;
wherein the lighting device further comprises a controller for controlling the light sources such that the lighting device is operable in at least a first mode in which the lighting device provides directional lighting.

2. A lighting device as claimed in claim 1 wherein the controller is adapted to control the light sources such that the lighting device is operable in a second mode in which the illumination provided by the lighting device subscribes 360° in the plane of the lighting device.

3. A lighting device as claimed in claim 1 wherein the controller is adapted to control each light source independently of the other light sources.

4. A lighting device as claimed in claim 1 and comprising N light sources, the light sources being disposed such that a line from a centre of the lighting device to one light source is at an angle of substantially 360°/N to a line from the centre of the lighting device to an adjacent light source.

5. A lighting device as claimed in claim 1 wherein the optical system comprises a plurality of first optical elements, each first optical element being associated with a respective source and being adapted to direct light from its associated light source along a respective direction.

6. A lighting device as claimed in claim 1 wherein the optical system is a reflective optical system.

7. A lighting device as claimed in claim 6 wherein each first optical element is a reflector.

8. A lighting device as claimed in claim 7 wherein each first element is a specular reflector.

9. A lighting device as claimed in claim 7 wherein each first optical element is a diffuse reflector.

10. A lighting device as claimed in claim 5 wherein each first optical element is a lens or a lightguide.

11. A lighting device as claimed in claim 5 wherein the optical system further comprises a plurality of second optical elements, each second optical element disposed in the path of light from a respective one of the first optical elements.

12. A lighting device as claimed in 11 wherein the second optical elements comprise lenses, prism arrays or diffusers.

13. A lighting device as claimed in claim 5 wherein the optical system further comprises a second optical element disposed in the paths of light from the first optical elements.

14. A lighting device as claimed in claim 13 wherein the second optical element is a diffuser, a lens, or a reflector.

15. A lighting device as claimed in claim 1 wherein the optical system is arranged to restrict the emission of light in a direction substantially perpendicular to the plane of the lighting device.

16. A lighting device as claimed in claim 1 wherein at least one of the light sources has different spectral characteristics to at least another one of the light sources.

17. A lighting device as claimed in claim 1 wherein at least one, and preferably all, of the light sources comprises a plurality of light-emitting elements.

18. A lighting device as claimed in claim 17 wherein at least one of the light-emitting elements in a light source is operable independently of the other light-emitting element (s) of the light source.

19. A lighting device as claimed in claim 17 wherein at least one of the light-emitting elements of a light source has different spectral characteristics to at least another one of the light-emitting elements of the light source.

20. A lighting system comprising a lighting device as defined in claim 1 and one or more sensors, the or each sensor providing a respective output signal as an input to the controller.

21.-23. (canceled)
